(19) United States
(12) Patent Application Publication
(10) Pub. No.: US 2014/0207630 A1
(43) Pub. Date: Jul. 24, 2014

(54) METHOD FOR TRANSACTIONAL PREDICTION AND ESTIMATION

(71) Applicant: OUTRIGHT INC., Mountain View, CA (US)

(72) Inventors: Steven Philip Aldrich, Los Altos, CA (US); Benjamin Max Curren, San Jose, CA (US); Laurel Kate Lee, San Carlos, CA (US)

(73) Assignee: OUTRIGHT INC., Mountain View, CA (US)

(21) Appl. No.: 13/747,577

(22) Filed: Jan. 23, 2013

(51) Int. Cl. G06Q 30/00

(52) U.S. Cl. CPC G06Q 30/018
USPC 705/30

(57) ABSTRACT

A method for transactional prediction and estimation is presented. The method can include assembling, using a computer system, at least one of transactional data and financial data acquired from at least one online transaction partner of a transaction source, and generating, using the computer system, a predicted regulatory reporting obligation based on the at least one of transactional data and financial data. Upon determining, using the computer system, the predicted regulatory reporting obligation includes a regulatory reporting about the transaction source by the at least one online transaction partner, the method includes generating a report of estimated financial reporting data including potential expenses incurred by the transaction source.

### CROSS-REFERENCE TO RELATED APPLICATIONS

This application is related to U.S. patent application Ser. No. ______, filed on ______, and entitled “SYSTEM FOR TRANSACTIONAL PREDICTION AND ESTIMATION.”

### BACKGROUND OF THE INVENTION

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between users. Hundreds of millions of people around the world have access to computers connected to the Internet via Internet Service Providers (ISPs). Content providers distribute content, such as multimedia information, including text, graphics, audio, video, animations, and other forms of data to consumers using the Internet. In addition, businesses utilize the Internet to facilitate business transactions and communicate between buyers and sellers, suppliers and customers, and many other entities.

Many businesses act as merchants offering and selling goods and services to individuals and organizations that form the customers of the merchants. Individual websites and larger business platforms allow individuals and businesses to share their information and conduct business with a large number of buyers and sellers.

The Internet has been elevated to an essential tool of commerce around the world and its prevalence in business continues to expand. The Internet continues to be increasingly valuable to individual users and businesses alike. Many people use the Internet for everyday tasks, from social networking, shopping, banking, and paying bills to consuming media and entertainment. Thus, the buying and selling of products or services over electronic systems such as the Internet, or eCommerce, continues to grow.

Not surprisingly given the increasing prevalence of the Internet and eCommerce in business transactions and the increasing percentage of domestic and international transactions that involve the Internet and eCommerce, governments have sought to regulate business transactions conducted over the Internet. Generally, because the Internet, by its nature, is not confined to a particular nation or state, regulation of such transactions involving the Internet has been difficult. Nevertheless, regulation of such transactions continues to be implemented nationally and internationally.

Governments and regulators have struggled since the very earliest days of the Internet's existence to conceive of practical regulations and, primarily, taxation structures that could be implemented in a feasible and reasonable fashion despite the Internet's nature as a global infrastructure that is, by design, devoid of centralized control. As the percentage of business transactions involving the Internet has grown, often at the expense of traditional transactions occurring at so-called “brick-and-mortar” stores or other sales transactions that are localized in a particular municipality, state, and/or nation, governments and regulators have moved to enact regulations and taxations that address this growing segment of local and global economies.

Since the Internet is devoid of centralized governance, the regulation and taxation strategies have generally focused on self-reporting obligations. These self-reporting obligations can present a substantial burden on businesses that utilize the Internet because the obligations assume that the reporting business has information about a very-broad range of topics. For example, such regulations typically assume that the reporting business has a substantial understanding of its customers, its service providers, and the relevant regulations that govern a given transaction, despite the fact that the regulations include municipal, state, federal, and multi-national regulations with competing and, often, conflicting requirements.

Therefore, it would be desirable to have a system and method for assisting businesses with tracking and complying with regulations of business transactions.

### BRIEF DESCRIPTION OF THE DRAWINGS

FIG. 1 is a schematic block diagram of an exemplary system and operating environment in accordance with the present disclosure.

FIG. 2 is a flow chart setting forth exemplary steps of a method in accordance with the present disclosure and capable of being carried out in the system and operating environment of FIG. 1.

FIG. 3 is an exemplary report of synthesized data spanning a plurality of transactions involving a plurality of data sources created in accordance with the present disclosure.

FIG. 4 is an exemplary regulatory report provided by an estimation engine in accordance with the present disclosure.

FIG. 5 is a schematic block diagram showing an exemplary transaction and finance tracking system.

### DETAILED DESCRIPTION OF THE PREFERRED EMBODIMENT

The present invention overcomes the aforementioned drawbacks by providing a system and method for tracking business transactions and regulations and predicting and estimating information to complete accurate reporting compliance with respect to applicable regulations.

In accordance with one aspect of the invention, a method is disclosed that includes assembling, using a computer system, at least one of transactional data and financial data acquired from at least one online transaction partner of a transaction source, wherein the transaction source and the at least one online transaction partner are separate entities. The method also includes analyzing, using the computer system, the at least one of transactional data and financial data to determine whether a predetermined threshold has been reached and generating, using the computer system, a predicted regulatory reporting obligation based on the analyzing. Upon determining, using the computer system, the predicted regulatory reporting obligation includes a regulatory reporting about the transaction source by the at least one online transaction partner, the method includes generating a report of estimated financial reporting data including potential expenses incurred by the transaction source and indicating the potential expenses as reducing a gross financial total of the regulatory reporting about the transaction source by the at least one online transaction partner.

In accordance with another aspect of the invention, a method is disclosed that includes assembling, using a computer system, at least one of transactional data and financial data acquired from at least one online transaction partner of a transaction source. The method also includes generating, using the computer system, a predicted regulatory reporting obligation based on the at least one of transactional data and financial data. Upon determining, using the computer system, the predicted regulatory reporting obligation includes a regulatory reporting about the transaction source by the at least one online transaction partner, the method includes generating a report of estimated financial reporting data including potential expenses incurred by the transaction source.

In accordance with yet another aspect of the invention, a system is disclosed that includes at least one server computer communicatively coupled to a network. The at least one server computer is configured to assemble at least one of transactional data and financial data acquired from at least one online transaction partner of a transaction source, wherein the transaction source and the at least one online transaction partner are separate entities. The server computer is also configured to analyze the at least one of transactional data and financial data to determine whether a predetermined threshold has been reached and generate a predicted regulatory reporting obligation based on the analysis. The server computer is further configure to, upon determining the predicted regulatory reporting obligation includes a regulatory reporting about the transaction source by the at least one online transaction partner, generate a report of estimated financial reporting data including potential expenses incurred by the transaction source and indicating the potential expenses as reducing a gross financial total of the regulatory reporting about the transaction source by the at least one online transaction partner.

In accordance with still another aspect of the invention, a system is disclosed that includes at least one server computer communicatively coupled to a network. The at least one server computer is configured to assemble at least one of transactional data and financial data acquired from at least one online transaction partner of a transaction source and generate a predicted regulatory reporting obligation based on the at least one of transactional data and financial data. The at least one server computer is further configured to, upon determining the predicted regulatory reporting obligation includes a regulatory reporting about the transaction source by the at least one online transaction partner, generate a report of estimated financial reporting data including potential expenses incurred by the transaction source.

Thus, the present disclosure relates to a system and method for transaction tracking, regulatory reporting, and report estimating conducted over communications networks using information acquired from disparate sources. More specifically, the present disclosure relates to systems and methods for tracking financial and business transactions to predict when reporting to regulatory agencies is required and provide updated reports to regulatory agencies having increased accuracy over traditional reports provided to regulatory agencies.

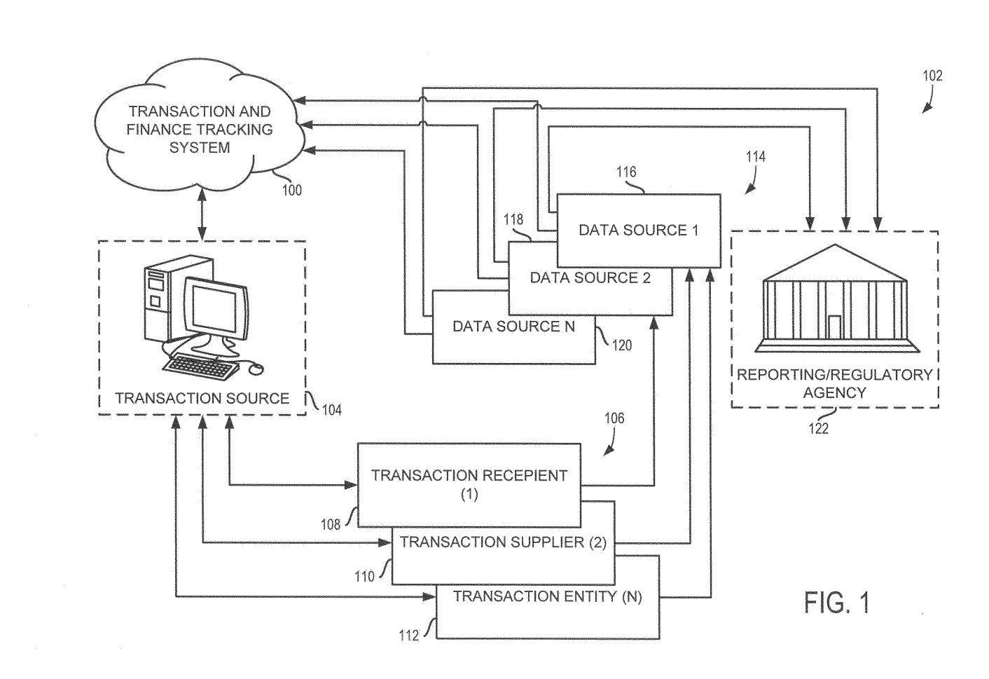

Referring to FIG. 1, a transaction and finance tracking system 100 is shown along with an associated operating environment 102. The operating environment 102 includes a “transaction source” 104, such as a business, that conducts business with various “transaction entities” 106. More particularly, the transaction entities 106, as illustrated, may include various different entities. The transaction entities are numbered and may vary in number, as illustrated by the enumeration extending to variable “N”. The transaction entities 106 may include, for example, a “transaction recipient” 108, such as a customer, a “transaction supplier” 110, such as a supplier that provides goods or services to the transaction source 104 to allow the transaction source 104 to complete transactions, and other transaction entities 112.

The operating environment 102 also includes a plurality of data sources 114. The plurality of data sources 114 may be online transactional partners that facilitate or are involved in one or more parts of a given transaction. In this regard, the plurality of data sources 114 may be embodied as a variety of entities that interact within the context of or receive or hold information about a transaction between the transaction source 104 and any of the plurality of transaction entities 106. The plurality of data sources 114 may vary in number, as indicated by the enumeration of the data sources including data source “1” 116, data source “2” 118, and data source “N” 120. Examples of data sources may include financial institutions, such as banks, credit card companies, credit card processors, and other institutions engaging in or involved with the processing of financial transactions. Other examples of data sources may include transaction facilitators, such as retail or auction facilitators or other sales or transaction facilitators. Some non-limiting examples may include entities providing services, such as online auction or sales services provided by EBAY Inc, payment or transaction facilitation services provided by PAYPAL Inc., and retail or affiliated retail services associated with AMAZON.COM, Inc. Other examples of the data sources 114 may include databases and records holding entities, both independent from and/or internal to the transaction source 104.

Furthermore, the operating environment 102 includes a reporting or regulatory agency 122. The reporting or regulatory agency 122 may include any of a variety of entities both separate from or constituting part of other ones of the entities described above. For example, the reporting or regulatory agency 122 may include the Internal Revenue Service (IRS) or other taxation and taxation tracking agencies. Also, the reporting or regulatory agency 122 may include the Federal Trade Commission (FTC), Environmental Protection Agency (EPA), or other governmental or quasi-governmental agency that has regulatory power. Also, the reporting or regulatory agency 122 may include non-governmental entities and may include other entities related to the entities described above, for example, including a parent or related company to the transaction source 104.

The transaction and finance tracking system 100 is configured to operate in the above-described environment 102, which may include all or some of the above-described entities, as well as many other entities. Advantageously, the transaction and finance tracking system 100 may operate independently from the other entities and, as illustrated, may be embodied as a service configured to be accessed over the Internet. In this regard, the transaction and finance tracking system 100 may readily communicate with any or all of the above-described entities in the operating environment 102. Alternatively, the transaction and finance tracking system 100 may be designed to communicate with the transaction source 104 and the plurality of data sources 114.

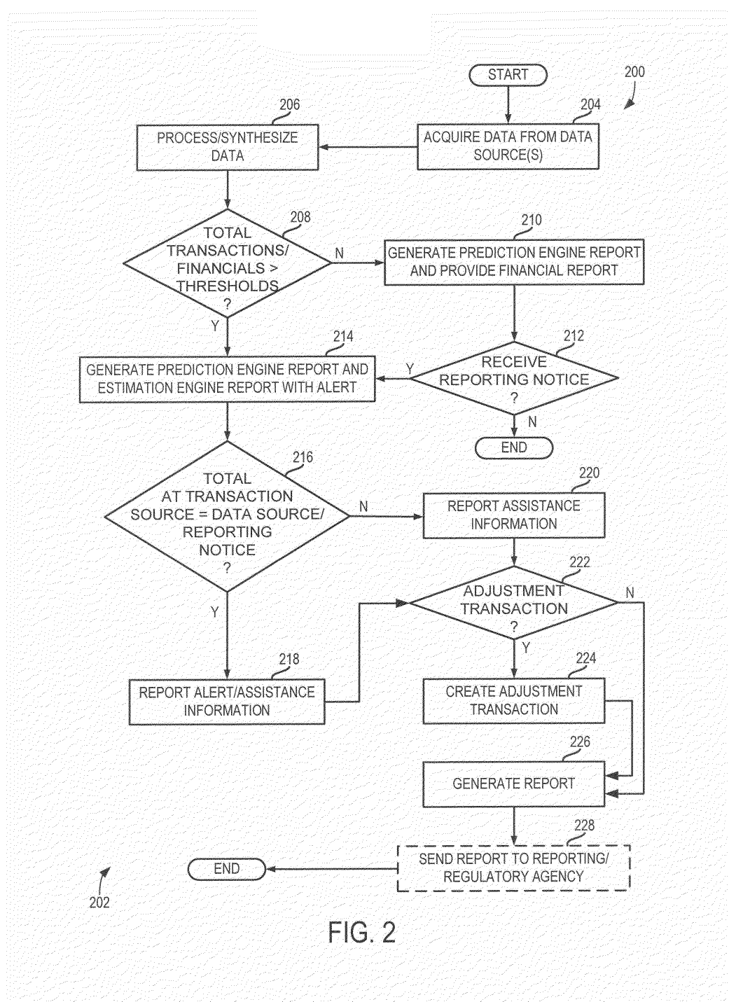

Referring now to FIG. 2, a flow chart is provided setting forth exemplary steps taken by the transaction and finance tracking system 100 of FIG. 1 for transaction tracking, regulatory reporting, and report estimating conducted over communications networks using information acquired from disparate sources. As will be described, the overall process can be conceptualized as including two sub-processes performing the exemplary steps of a prediction engine 200 and a reporting estimation engine 202. In the present example, the process will be described with respect to the steps performed by the prediction engine 200 directed to predicting a required regulatory reporting and the steps performed by the reporting estimation engine 202 directed to generating a financial regulatory report. More particularly, in the present example, the steps performed by the prediction engine 200 will be described with respect to predicting whether a regulatory reporting required by a governmental agency, such as the IRS, is anticipated. Further still, in the present example, the steps performed by the prediction engine 200 will be described with respect to predicting whether a report required using form 1099-K of the IRS is anticipated. In this example, the steps performed by the reporting estimation engine 202 will be described with respect to financial information associated with form 1099-K of the IRS.

The process begins at process block 204 by assembling data acquired from one or more data sources. Specifically, as illustrated in FIG. 1, the transaction and finance tracking system 100 may be configured to receive information from the plurality of data sources 114. As described above, this information may include transaction and financial information from financial institutions, including banks, credit-card companies and processors, and the like. Also, this information may include transaction and financial information from entities like EBAY Inc., PAYPAL Inc., and AMAZON.COM Inc. In this regard, the information from the plurality of data sources 114 may be in disparate forms and have related or redundant information.

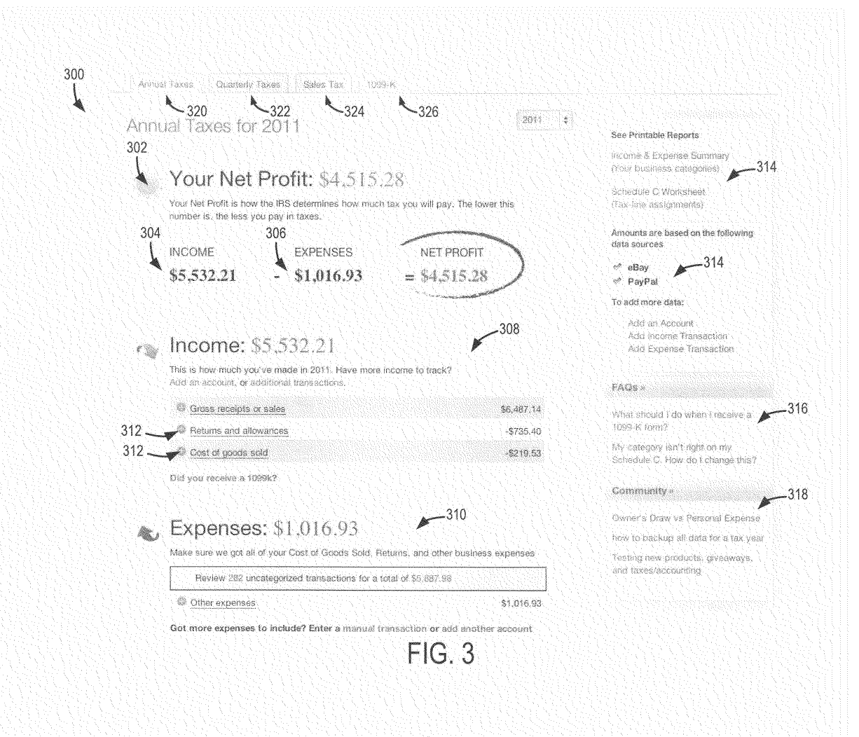

At process block 206, the acquired data is synthesized. The data may be synthesized into a financial summary statement or, as illustrated in FIG. 3, an annual taxes overview report 300, such as a report formatted as a web or Internet-accessible interface. The report 300 may include an indication 302 of a net profit earned based upon a summation of transaction values identified in the acquired data. The net profit earned may be further broken down by an indication of total income 304 and total expenses 306 that offset that income.

The report 300 can also include a detailed income section 308 that provides a user with more fine-grained information describing various attributes of the income summarized by indication 304. Income section 308 may depict such information as a total amount of gross receipts or sales, offset by a total amount of returns and allowances and total cost of goods. A detailed expenses section 310 may also be included to provide a further breakdown of expenses. The detailed expenses section 310 may include a listing of amounts of expenses broken down by categories of expenses, for example.

The information provided in both the detailed income section 308 and detailed expenses section 310 of the report 300 may include user interfaces 312 such as hyperlinks, buttons, or toggle controls to expand or collapse certain elements of the detailed sections of the report 300.

Although the report 300 depicted in FIG. 3 represents an output that may be generated via a web page, the report 300 includes a number of links 314 (or other suitable user interfaces) that a user can execute to download or otherwise retrieve or print reports having alternative formats and/or depicting different types of data, such as a summary report for income and expenses, or a schedule C worksheet.

The report 300 includes a listing 314 of data sources from which the acquired data was retrieved. This listing enables a user to quickly confirm that the report 300 was created using an accurate set of acquired data and that necessary data sources were not incorrectly absent from or included in the acquired data set.

Finally, the report 300 may include a FAQ or other listing of helpful information 316 to assist a user in understanding and utilizing the information depicted in the report 300. For additional information, the report 300 can also include relevant links to community forums 318 allowing a user to access various community discussions relevant to the report 300 and its contents.

A number of tabs can be provided in combination with the report 300 to enable a user to access other relevant reports or web pages. For example, as depicted in FIG. 3, at the top of the report 300 tabs are provided to enable a user to access an annual taxes report 320, quarterly taxes report 322, sales tax report 324, or 1099-K report 326.

Referring again to FIG. 2, with the data processed, which notably may be ongoing or regularly changing or updating, at decision block 208, the steps of the prediction engine 200 determine whether a regulatory reporting is anticipated. Namely, under this example, decision block 208 may consider a total number of transactions and a total of financial information in the processed data against respective thresholds, such as a number of transactions or an amount of revenue. In the context of predicting whether a form 1099-K report will be issued by a given data source in the plurality of data sources 114 of FIG. 1 or should be completed by the transaction source 104, the transaction and finance tracking system 100 compares the transactions and financial information against respective thresholds, such as 200 transactions and $20,000, respectively. If the total transactions are below 200 transactions or the financial totals are below $20,000, a prediction engine report is generated that indicates that no reporting is anticipated in step 210.

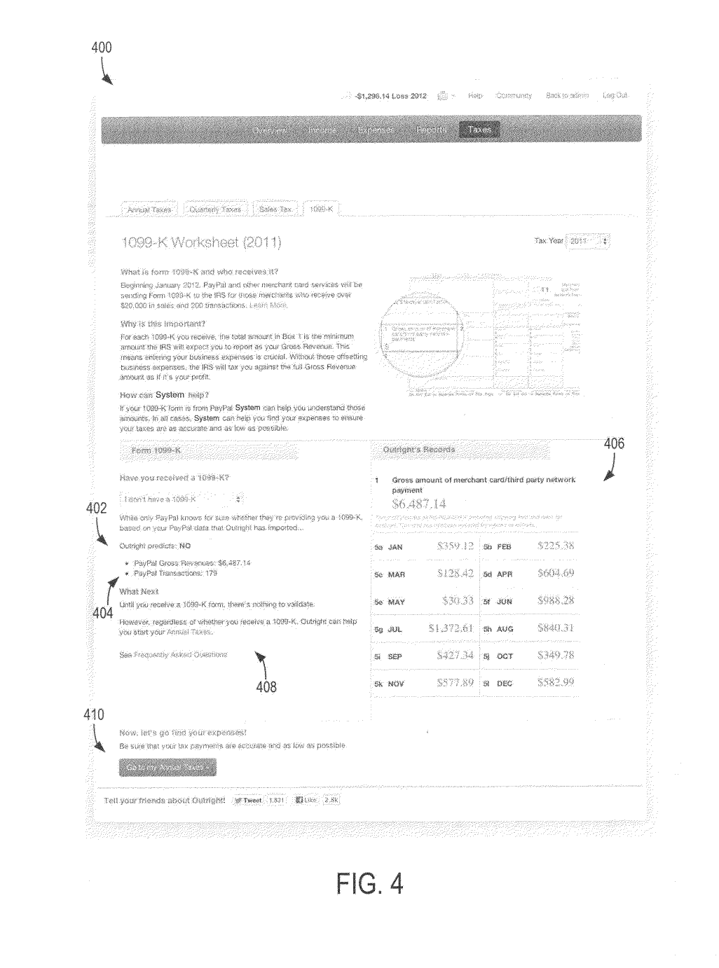

For example, referring to FIG. 4, an exemplary report 400 may include a prediction indication 402. Notably, the thresholds may be considered independently or dependently. In the latter event, a failure of comparison against either threshold can result in a negative prediction indication. In the former event, a failure of comparison against both thresholds results in a negative prediction indication. In either case, it may be advantageous to indicate in the report 400 where the failure occurred or, as illustrated, the financial and/or transactional totals 404. For example, the transaction and finance tracking system 100 of FIG. 1 may be acquiring and processing data from a plurality of data sources 114, as described above. In this case, the transaction and finance tracking system 100 may need to consider both combined totals of financial and transactional data and totals from individual data sources in generating the prediction 402 indication. For example, if a given data source, such as PayPal Inc., provides data that totals less than 200 transactions, such as 179 transactions, and less than $20,000 in gross revenue, such as $6,487.14, no 1099-K is predicted to be issued by the PayPal Inc. data source. However, another data source may surpass these thresholds and, thus, an indication that a 1099-K from that other data source will be indicated. Of course, the gross revenue reported by a given data source is an incomplete representation of the gross revenue of the transaction source 104 of FIG. 1, if the transaction source 104 is utilizing a plurality of data sources 114. In this regard, the report 400 of FIG. 4 may also indicate the gross revenue and transaction totals across multiple data sources and/or may divide such information by monthly or other periodic intervals 406.

Referring again to FIG. 2, even if the prediction engine indicates in the generated report that no 1099-K or other regulatory reporting is anticipated, at decision block 212, the system may inquire whether a reporting notice was received. In this regard, there is an additional check on a discrepancy between the assembled data from the plurality of data sources and the actions of the data sources. If no reporting is predicted and no reporting notice received at decision block 212, the process can end.

However, if a reporting notice is received at decision block 212 or, at decision block 208 the thresholds are surpassed, the prediction engine generates a report alerting the user that regulatory reporting is anticipated and/or necessary at process block 214. With this information, at decision block 216, a check is made to compare the data supplied by the transaction source 104 of FIG. 1 to the transaction and finance tracking system 100 against the assembled data from the plurality of data sources 114. Specifically, the total, for example, gross totals and/or totals individualized for a given data source, may be compared to determine whether there is a discrepancy.

If there is a discrepancy, such that gross or individual transactional or financial information supplied by the transaction source 104 to the transaction and finance tracking system 100 does not match the assembled or individual data from the plurality of data sources 114, a report with assistance information is supplied at process block 218. For example, at process block 218, the report may indicate potential reasons for the discrepancy. As indicated in FIG. 4, this assistance information may include guidance or information regarding common reasons for inconsistencies or discrepancies 408. Also, the assistance information may include a prompt for an adjustment transaction, such as indicated at optional process block 222. For example, as illustrated in FIG. 4, a common reason for a discrepancy or difference may be the inclusion of expense data.

On the other hand, if there is no discrepancy, a different report may be generated at process block 220. Even if no discrepancy is determined, the report generated at process block 220 may indicate potential expenses or help educate the user regarding expenses that may be deducted from taxable revenue.

Notably, the plurality of data sources 114 of FIG. 1 are not privy to the expenses incurred by the transaction source 104 and reported by the transaction source 104 to the transaction and finance tracking system 100. However, such information is germane to the reporting of taxable revenue of the transaction source 104. Unfortunately, however, since the plurality of data sources 114 are not aware of such information and may be required to report financial and transactional information directly to the reporting/regulatory agency 122 of FIG. 1, it is incumbent upon the transaction source 104 to correct these inconsistencies with accurate and detailed explanations, else pay undue taxes or other such regulation-based fees. If there are inconsistencies that cannot be tied back to an expense, it may also be desirable to create an adjustment transaction, such as requested at decision block 222. The adjustment transaction may or may not correlate to an expense. The entry of expenses or other adjustment transactions can be entered at process block 224.

At process block 226, a report is generated. This report can be formatted for direct reporting to the reporting/regulatory agency 122 of FIG. 1 for use by the reporting/regulatory agency 122 (e.g., by formatting the report according to a standard report format provided or established by the reporting/regulatory agency 122) or may take other forms. If formatted for direct reporting to the reporting/regulatory agency 122, for example, such as formatted according to a 1099-K form, the report may be, optionally, directly sent to the reporting/regulatory agency 122 at optional process block 228, such as directly by the transaction source 104 or directly from the transaction and finance tracking system 100 to the reporting/regulatory agency 122.

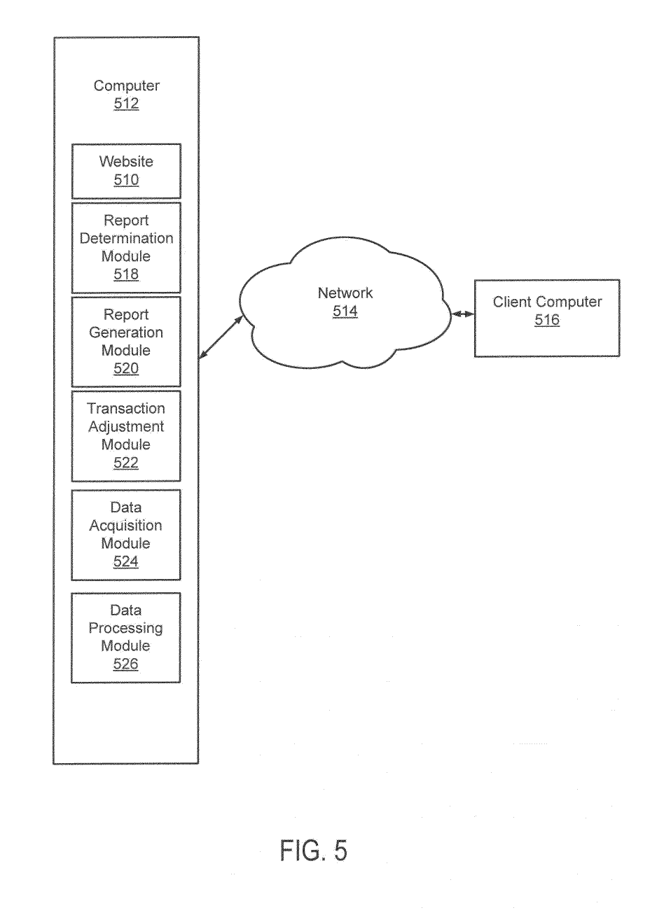

FIG. 5 is a schematic block diagram showing an exemplary transaction and finance tracking system in accordance with the present disclosure. The system is generally configured to execute a method such as that depicted in FIG. 2. The system may include a website 510 hosted on at least one server computer 512 communicatively coupled to a network 514. Website 510 may be utilized to collect data from a user (such as data used to initiate report generation) or to generate and transmit reports, such as those of FIGS. 3 and 4, via network 514. In one implementation, a user interacts with website 510 of the computer 512 using a client computer 516, described below.

Computer 512 includes a report determination module 518 configured to determine whether a regulatory reporting is anticipated, such as by implementing step 208 depicted in FIG. 2. Computer 512 also includes a report generation module 520 configured to generate one or more reports, for example, in accordance with the method of FIG. 2. Example reports include the report of synthesized data depicted in FIG. 3, or the report provided by an estimation engine in accordance depicted in FIG. 4. Computer 512 may also include a transaction adjustment module 522 configured to implement, for example, steps 222 and 224 of FIG. 2, a data acquisition module 524 configured to acquire data from a number of sources and a data processing module 526 configured to synthesize data received from the data acquisition module 524, for example, in accordance with step 206 of FIG. 2.

In FIG. 5 network 514 could comprise the Internet, the public switched telephone network, the global Telex network, computer networks (e.g., an intranet, an extranet, a local-area network, or a wide-area network), wired networks, wireless networks, or any combination thereof.

Computer 512 may include one or more server computers communicatively coupled to the network 514 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared DataAssociation (IrDA), wireless, WAN technologies (TI, Frame Relay), Point-to-Point Protocol over Ethernet (PPPoE), and/or any combination thereof. As non-limiting examples, computer 512 could be application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, or any combination thereof).

Client computer 516 may be used to connect to the network 514 to use the illustrated embodiments and may include a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture.

Each module illustrated in FIG. 5 may comprise a self-contained software component that may interact with the larger system and/or other modules. A module may comprise an individual (or plurality of) file(s) and may execute a specific task within a larger software and/or hardware system. As a non-limiting example, a module may comprise any software and/or scripts running on at least computer 512 containing instructions (perhaps stored in computer-readable media accessible by the computer's processor) that, when executed by the computer processor, cause the computer to perform one or more of data acquisition (e.g., element 524 performing step 204 of FIG. 2), data processing (e.g., element 526 performing step 206 of FIG. 2), report determination (e.g., element 518 performing one or more of the steps depicted in FIG. 2 to determine whether a regulatory reporting is anticipated), generate one or more reports (e.g., element 520 performing steps 210, 214, 218, 220, and/or 226 of FIG. 2), or transaction adjustment (e.g., element 522 performing steps 222 and/or 224 of FIG. 2).

In some implementations, the computer 512 and, consequently, the transaction and finance tracking system are implemented as a highly-distributed system, wherein the website 512 and one ore more of modules 524, 526, 518, 520, and 522 run on separate computers 512. In alternate embodiments, each module run on a single server, a grid computing solution, a cloud computing solution, and/or any combination thereof. Grid computing may refer to a network of servers interconnected in a grid and running in parallel to maximize computing power. Cloud computing may refer to a model of networked data storage and/or computing functionality where data and software may be stored and/or run on multiple virtual servers, generally hosted by third parties, rather than being hosted on dedicated servers.

Therefore, a system and method is provided for tracking business transactions and regulations and predicting and estimating information to complete accurate reporting compliance with respect to applicable regulations. The system and method are versatile and can be designed to span multiple data sources and, in fact, can span multiple, transaction sources, such as related companies or divisions of a company.

As a non-limiting example, the steps described above (and all methods described herein) may be performed by any central processing unit (CPU) or processor in any computer or computing system, such as a microprocessor running on a server computer, and executing instructions stored (perhaps as applications, scripts, apps, and/or other software) in computer-readable media accessible to the CPU or processor, such as a hard disk drive on a server computer, which may be communicatively coupled to a network (including the Internet). Such software may include server-side software, client-side software, browser-implemented software (e.g., a browser plugin), and other software configurations.

This present disclosure describes preferred embodiments with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention has been described in terms of one or more preferred embodiments, and it should be appreciated that many equivalents, alternatives, variations, and modifications, aside from those expressly stated, are possible and within the scope of the invention.

1. A method, comprising:
a) assembling, using a computer system, at least one of transactional data and financial data acquired from at least one online transaction partner of a transaction source, wherein the transaction source and the at least one online transaction partner are separate entities;
b) analyzing, using the computer system, the at least one of transactional data and financial data to determine whether a predetermined threshold has been reached;
c) generating, using the computer system, a predicted regulatory reporting obligation based on step b); and
d) upon determining, using the computer system, the predicted regulatory reporting obligation includes a regulatory reporting about the transaction source by the at least one online transaction partner, generating a report of estimated financial reporting data including potential expenses incurred by the transaction source and indicating the potential expenses as reducing a gross financial total of the regulatory reporting about the transaction source by the at least one online transaction partner.

2. The method of claim 1, wherein the predetermined threshold includes a threshold number of transactions in the transactional data or a threshold amount of revenue in the financial data.

3. The method of claim 1, wherein the predetermined threshold includes a threshold number of transactions in the transactional data and a threshold amount of revenue in the financial data.

4. The method of claim 1, wherein, when step b) fails, the predicted regulatory reporting obligation is negative.

5. The method of claim 1, wherein the report of estimated financial reporting data indicates a transaction total for each of a plurality of data sources.

6. The method of claim 1, including formatting, using the computer system, the report of estimated financial reporting data for use by a regulatory agency.

7. The method of claim 6, including transmitting, using the computer system, the report of estimated financial reporting data formatted to match an internal revenue service (IRS) form 1099-K.

8. The method of claim 1, further comprising prompting, using the computer system, for an adjustment transaction.

9. The method of claim 8, including, after receiving the adjustment transaction, modifying, using the computer system, the report of estimated financial reporting data in accordance with the adjustment transaction.

10. A method, comprising:
a) assembling, using a computer system, at least one of transactional data and financial data acquired from at least one online transaction partner of a transaction source;
b) generating, using the computer system, a predicted regulatory reporting obligation based on the at least one of transactional data and financial data; and
c) upon determining, using the computer system, the predicted regulatory reporting obligation includes a regulatory reporting about the transaction source by the at least one online transaction partner, generating a report of estimated financial reporting data including potential expenses incurred by the transaction source.

11. The method of claim 10, wherein the transaction source and the at least one online transaction partner are separate entities.

12. The method of claim 10, wherein the report of estimated financial report data indicates the potential expenses as reducing a gross financial total of the regulatory reporting about the transaction source by the at least one online transaction partner.

13. The method of claim 10, wherein generating a predicted regulatory reporting obligation includes analyzing the at least one of transactional data and financial data to determine whether a predetermined threshold has been reached.

14. The method of claim 13, wherein the predetermined threshold includes a threshold number of transactions in the transactional data or a threshold amount of revenue in the financial data.

15. The method of claim 13, wherein the predetermined threshold includes a threshold number of transactions in the transactional data and a threshold amount of revenue in the financial data.

16. The method of claim 10, wherein the report of estimated financial reporting data indicates a transaction total for each of a plurality of data sources.

17. The method of claim 10, including formatting, using the computer system, the report of estimated financial reporting data for use by a regulatory agency.

18. The method of claim 17, including transmitting, using the computer system, the report of estimated financial reporting data formatted for use by a regulatory agency to the regulatory agency.

19. The method of claim 10, further comprising prompting, using the computer system, for an adjustment transaction.

20. The method of claim 19, including, after receiving the adjustment transaction, modifying, using the computer system, the report of estimated financial reporting data in accordance with the adjustment transaction.
